(19) United States
(12) Patent Application Publication
(10) Pub. No.: US 2023/0124620 A1
(43) Pub. Date: Apr. 20, 2023

(54) MULTIPLE CARRIER-GONDOLA MACHINE

(71) Applicant: AVL MOTION GROEP B.V., Westerbeek (NL)

(72) Inventor: Arno Henricus Wilhelmus VAN LANKVELD, Westerbeek (NL)

(21) Appl. No.: 17/921,907

(22) PCT Filed: Apr. 29, 2021
(86) PCT No.: PCT/NL2021/050281

§ 371 Date: Oct. 27, 2022

(30) Foreign Application Priority Data
Apr. 30, 2020 (NL) 2025474

(51) Int. Cl. A01D 46/30; A01D 45/00; B65G 47/86

(52) U.S. Cl. CPC A01D 46/30; A01D 45/007; B65G 47/842; B65G 41/008

(57) ABSTRACT

The present invention is in the field of a multiple carrier-gondola machine comprising modules for transferring objects, a machine for transferring objects comprising at least one module (100), which may be used for various applications. An example of such an application is harvesting of vegetables, such as for harvesting of asparagus.

### FIELD OF THE INVENTION

The present invention is in the field of a multiple carrier-gondola machine comprising modules for transferring objects, a machine for transferring objects comprising at least one module, which may be used for various applications. An example of such an application is harvesting of vegetables.

### BACKGROUND OF THE INVENTION

Modules for transferring objects, such as for harvesting vegetables provided in rows, packaging machines, pick-and-order machines, pick-and-place machines, surface mount technology component placement systems, and postal selection and sorting machines, are widely used. These machines are typically provided with robotic components or the like. They can be used for high speed, high precision placing of a broad range of components, such as electronic components, for moving selected items/objects to a further location, for harvesting, and so on.

A disadvantage of such machines is that typically operation is performed in a static mode, that is the machine is at a given location, components/elements are at a second location, and the machine transfers to component/element to a second location. The second location may also be a position aside a conveyor belt carrying the object, which aside position may be a further conveyor belt. When the machine operates in less static conditions, typically relating to moving objects, or moving relative to a first position, precision and speed may be hampered.

The present inventors have developed a machine for harvesting vegetables, which is shown in WO 2019/098827 A2. Said machine functions as expected, harvesting more than a million asparagus per module in 3-4 months' time, with minimal wear and maintenance, but the present invention provides improvements to said machine.

As background art the following documents may be mentioned: CN 106 233 925 A, CN 109 429 700 A, and EP 3 498 076 A1 recite alternative modules with linear actuator. WO 2012/148278 A1 recites a module with endless driving means having carriers mounted thereon.

The present invention therefore relates to an improved module, and a machine comprising such a module, for no-static conditions, which solves one or more of the above problems and drawbacks of the prior art, providing reliable results, without jeopardizing functionality and advantages.

### SUMMARY OF THE INVENTION

It is an object of the invention to overcome one or more limitations of the devices of the prior art and to improve modules and machines thereof. In a first aspect the present invention relates to a module 100 for transferring objects, typically in a repetitive mode, and typically in an intermittent mode, such as moving these objects in a horizontal and/or vertical direction, comprising a frame 10 with a longitudinal axis, i.e. the machine typically is longer than wide, at least one first rotation system 20 comprising at least one individually operable rotator 21, each rotator connected to the rotation system, at least one carrier 30, each carrier connected to a rotator, preferably removably connected, wherein per rotator more than one carrier may be connected, such as 2-4 carries, preferably 2-20 carriers, the rotation system adapted to rotate the carrier, each carrier individually comprising a gondola 40, wherein said gondola is adapted to move within the carrier in a direction perpendicular to a movement of the carrier, wherein the gondola optionally also may rotate with respect to a suspension point, thereby providing movement which may be regarded as movement in an x-direction, per gondola an individually operable gondola driver 41 for moving the gondola within the carrier, each gondola comprising at least one object transferrer 42, wherein each rotator is individually operable for rotating the carrier along a continuous track 60, wherein said track comprises two substantially linear track parts 61 and two curved track parts 62 in between said two linear parts, which track may therefore be considered as “oval”-shaped, wherein said two substantially linear track parts are spaced apart and parallel to said longitudinal axis, which therefore provides two times a movement in a direction parallel to the longitudinal axis (which may be regarded as the y-direction), once advancing, and once reversing, at least one controller for controlling the individually operable rotator 21 and the gondola driver 41 such that a gondola is at a given position at a given time, the give position typically being a fixed position in a “space”, hence having a constant x,y,z, with respect to a location on earth, typically during a period of time, and at least one driving system 22 for driving the first rotation system and moving the gondola. In important part of the at least one first rotation system 20 is the at least one individually operable rotator 21, which in itself may already provide sufficient stability and accuracy. A track part 61 of a track 60 at a side where the gondola moves in a direction perpendicular to a movement of the carrier is considered most important, as it provides e.g. additional stability and accuracy to the present module. Therewith a rather generic module is provided which is suited for a large variety of functions, and which may be further adapted. The present module can for instance be used to move objects from a conveyor belt or the like, as the carrier may be provided with a speed substantially equal to the conveyor belt, and the gondola can then be used to move the objects, such as from the conveyor belt. The module can be used in a similar fashion on a vegetable harvesting machine. An example of such a harvesting machine is provided in WO 2019/098827, which document and its contents are incorporated by reference. So a simpler module is provided, which still provides reliable results under non-static conditions.

In a second aspect the present invention relates to a machine for transferring objects comprising at least one module according to the invention, typically comprising 2-50 modules.

Advantages of the present description are detailed throughout the description.

### DETAILED DESCRIPTION OF THE INVENTION

In an exemplary embodiment of the present module it may comprise at least two first rotation systems 20 each comprising at least one individually operable rotator 21, preferably 3-24 rotators 21, more preferably 4-12 rotators 21, such as 6-8 rotators 21.

In an exemplary embodiment of the present module per carrier two rotators 21 may be provided, wherein the two rotators are coupled to the carrier above/below one and another, respectively. Such provides improved stability, especially during movement, and in particular during acceleration or deceleration.

In an exemplary embodiment of the present module at least n carriers 30 are coupled to the same rotator 21, wherein n is two or more, preferably coupled 360/n degrees out of phase, preferably removably coupled. With one rotator more than one carrier can be operated, typically in an “frequency” mode.

In an exemplary embodiment the present module may comprise a feedback loop 70 for spatially cycling each carrier 30 from a back side to a front side of the frame 10 and from a front side to a back side of the frame 10.

In an exemplary embodiment of the present module the object transferrer 42 may be a tongs. Said tongs may grip an object, such as at a first location, and transfer it, such as to a second location.

In an exemplary embodiment the present module may comprise a carrier guidance 50, wherein the carrier guidance 50 may be adapted to move at a constant or zero speed.

In an exemplary embodiment of the present module the frame 10 may comprise at least one passage 14 for allowing rotation of the at least one carrier 30 in a cyclic manner.

In an exemplary embodiment of the present module the gondola may comprise an object transferrer 42 movable in a direction perpendicular to the longitudinal axis, in a vertical direction perpendicular to the longitudinal axis, and combinations thereof. Hence the present design provides a high amount of flexibility for moving gondolas around.

In an exemplary embodiment of the present module the gondola and/or the object transferrer 42 is rotatable along a first axis, and/or the gondola and/or the object transferrer 42 is rotatable along a second axis, therewith providing even more degrees of freedom.

In an exemplary embodiment of the present module the rotator 21 may be selected from a belt, a chain, a toothed belt, and combinations thereof.

In an exemplary embodiment of the present module the gondola driver may be selected from a belt, a chain, a toothed belt, and combinations thereof.

In an exemplary embodiment of the present module the gondola driver may be provided eccentric in the frame, such as 10-80% closer to a side of the frame where the gondola is adapted to move in a direction perpendicular to a movement of the carrier.

In an exemplary embodiment of the present module the at least one controller may comprise a closed loop, such as a feedback loop. Therewith, for instance when the present machine is moving at a speed of 1 m/sec, the accuracy of positioning the gondola is increased dramatically. The prior art system of WO 2019/098 827 A2 already was quite accurate at somewhat lower speeds, but at a speed of 1 m/sec the accuracy of positioning the gondola was about ±5 cm, whereas with the present system an accuracy of about ±1.5 mm is achieved.

In an exemplary embodiment of the present module the at least one controller may be adapted to move the gondola in a position closer to the frame as the carrier is in at least one of the two curved track parts in between said two linear parts, preferably in a position closest to the frame.

In an exemplary embodiment of the present module the gondola driver and/or rotator may be provided with a gear.

In an exemplary embodiment of the present module the carrier and gondola may be adapted to lock in with the gondola driver in one of the two curved track parts.

In an exemplary embodiment of the present module may comprise a calibration unit, preferably a calibration unit per carrier and gondola.

In an exemplary embodiment of the present module the gondola may be adapted to move at a speed v₂ larger than a speed v₁ of the carrier when the carrier left one of the two curved track parts and enters one of the two linear parts, wherein the gondola is adapted to move at a speed v₂ equal to a speed v₁ of the carrier when the carrier is in a mid-section of the one of the two linear parts, and wherein the gondola is adapted to move at a speed v₂ smaller than a speed v₁ of the carrier when the carrier leaves the one of the two linear parts and enters the second of the two curved track parts.

In an exemplary embodiment of the present module the gondola and carrier may be adapted to transfer an object within 2 secs, preferably within 1500 msecs, such as within 1200 msecs.

In an exemplary embodiment of the present machine it may be selected from harvesting machines, such as for harvesting vegetables provided in rows, such as asparagus, from packaging machines, such as for parcels, from pick-and-place machines, from surface mount technology component placement systems, from pick-and-order machines, from non-static machines, and from postal selection machines. The machine and method can in principle also be used for similar plants, especially Asparagaceae species in general, such as the genus of Asparagus, such as Asparagus officinalis, such as the genus of Ornithogalum, such as Ornithogalum pyrenaicum, and Cichorioideae species, such as Tragopogon, and Scorconera. Also other vegetables, such as of the Brassicaceae family.

In an exemplary embodiment of the present machine the gondola may be a cutting module comprising an tongs 43 for grasping an individual vegetable, a cutter 44, a vegetable locator 45, and wherein the cutting module is movably located in the carrier allowing movement in a horizontal direction perpendicular to the longitudinal axis.

In an exemplary embodiment of the present machine it may comprise a movable frame 10, the movable frame 10 comprising a motor 11 and wheels 12, a speed controller 13, and optionally at least one continuous track 16.

In an exemplary embodiment of the present machine it may comprise a central bottom passage 15 for allowing free movement of the machine over a row of vegetables.

In an exemplary embodiment of the present machine it may comprise a controller 35 for controlling the at least one carrier and gondola, frame speed, and feedback loop speed.

In an exemplary embodiment of the present machine it may comprise at least one location sensor 80, such as an optical sensor, for detecting an individual vegetable.

In an exemplary embodiment of the present machine it may comprise wherein the cutter comprises a vertical holder 47, such as a rod, a knife blade 48, and a knife blade protector 49, wherein the knife blade is adapted to rotate in a horizontal plane for cutting the individual vegetable.

In an exemplary embodiment of the present machine the vegetable locator 45 may comprise at least two horizontally rotatable tactile sensors 45a spaced apart at a distance of 1-10 cm, and oriented in a tapered geometry, such that a vegetable can be located.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### SUMMARY OF THE FIGURES

FIGS. 1-10a-c show certain aspects of the present machine and module.

### DETAILED DESCRIPTION OF FIGURES

In the figures:
100 module
10 frame
11 motor
12 wheels
13 speed controller
14 passage
15 bottom passage
16 continuous track
20 rotation system
21 rotator
22 rotation driving system
30 carrier
35 controller
40 gondola
41 gondola driver
42 gondola object transferrer
43 gondola tongs
44 cutter
45 vegetable locator
47 vertical holder
48 knife blade
49 knife blade protector
50 carrier guidance
60 continuous track
61 linear track
62 curved track
80 location sensor
200 machine

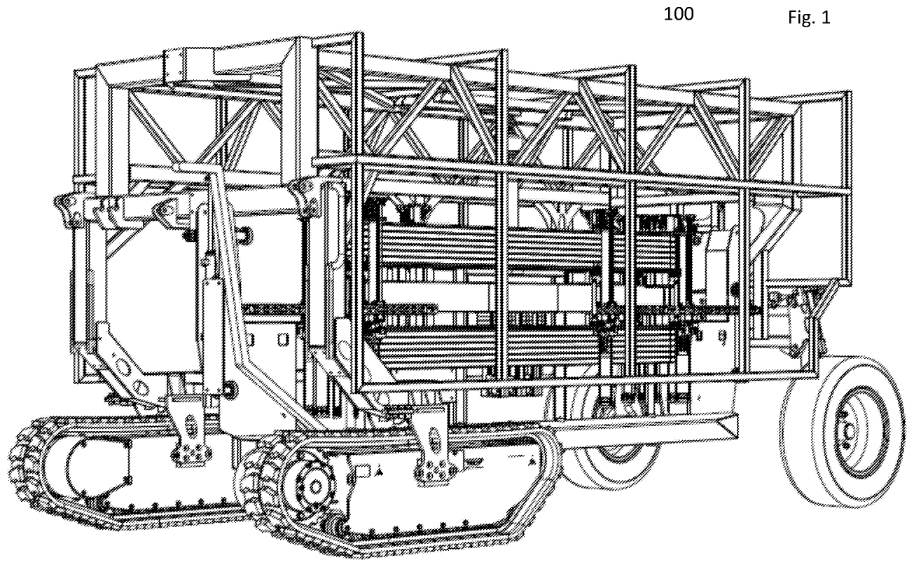

FIG. 1 shows the present machine 100 which is used for harvesting of vegetables, in particular of asparagus.

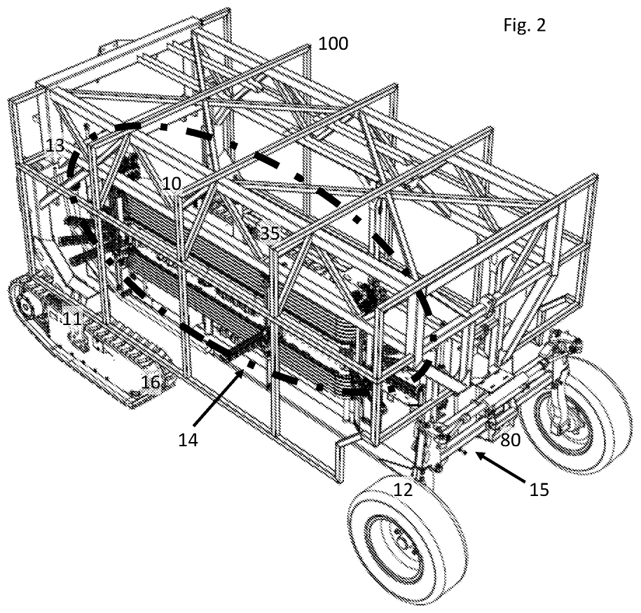

FIG. 2 shows a top view of the present machine 100 which is used for harvesting of vegetables. Therein a frame 10, a motor 11, wheels 12, a speed controller 13, a passage 14 for the carriers to move around, a continuous track 16, a bottom passage 15, a controller 35, and a location sensor are visible. In general the machine resembles that of the WO 2019/098827 at least to some extent.

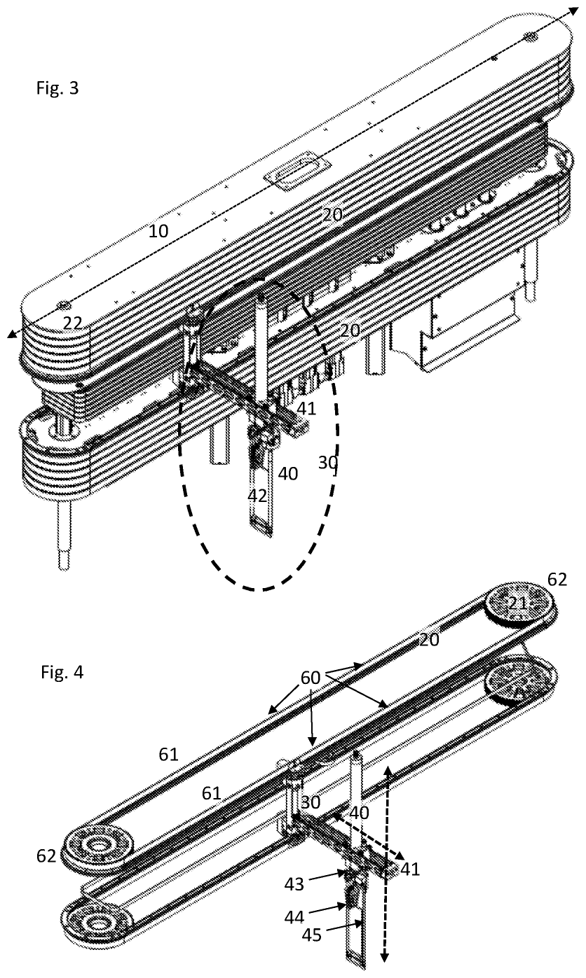

FIG. 3 shows details of the present frame 10 with a longitudinal axis, the rotation systems 20, rotation driving systems 22, carrier 30, gondola 40, and gondola drive 41. Only one carrier is shown, for clarity reasons only. The carrier can rotate around frame 10 and is attached to rotators 21 (see FIG. 4) which are driven by system 22.

FIG. 4 shows details of movement of the present carrier and gondola. Carrier 30 moves along track 60, which has two substantially straight parts 61 and two curved parts 62. The carrier 30 is attached to two rotation systems, one provided at a top side of the carrier, and one at a bottom side, which two rotation systems provide a well-controlled rotation. The rotation may be intermitted by backward movement, such as to compensate for movement of the machine, or to align with movement of a conveyor belt. When the carrier is in a position for further action, the gondola may be moved in an x-direction, and/or in a z-direction, as indicated with arrows. The gondola may be adapted for harvesting, as is shown in the figure, such as by providing tongs 43, a cutter 44, a vegetable locator 45, and an object transferrer 42.

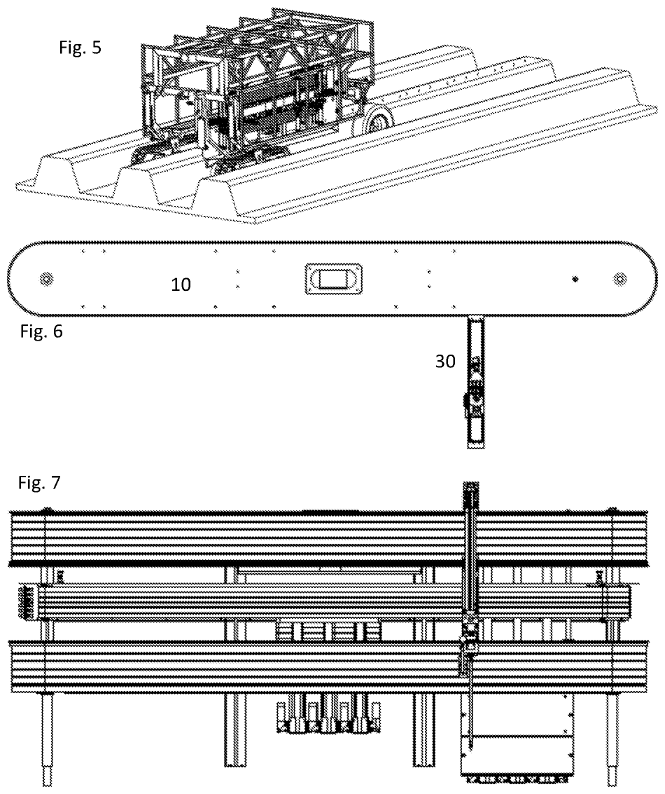

FIG. 5 shows schematics of an asparagus machine in operation.

FIG. 6 shows a top view of a frame and a carrier.

FIG. 7 shows a side view of FIG. 6, further having at a rear side a few carriers in a waiting position.

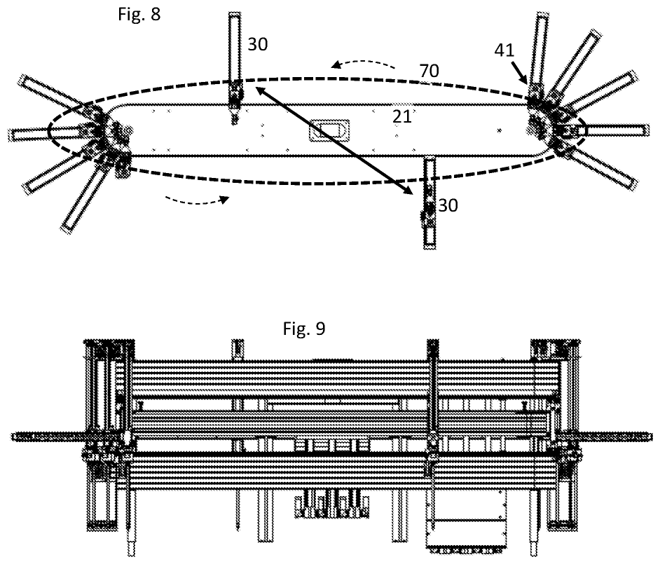

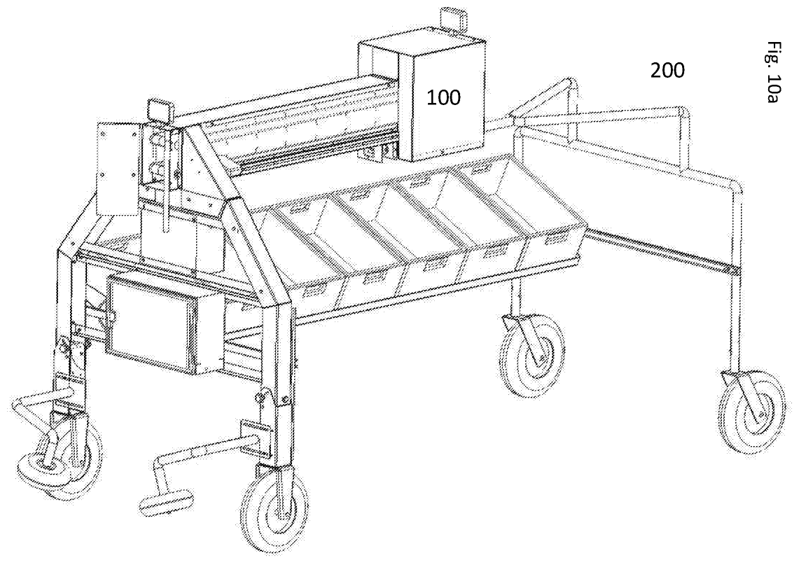

FIG. 8 shows a top view, comprising 10 carriers, which are coupled two by two (represented by the arrow), which move anti-clockwise as indicated over a feedback loop, such that after performing a task at a lower side of the module, and optionally releasing an object, they are ready for a repetition of the task. Each set of two carriers is attached to one and the same rotator 21, or to two or more rotators. The gondola driver is position as close as possible to the centre of the module. FIG. 9 shows a side view thereof.

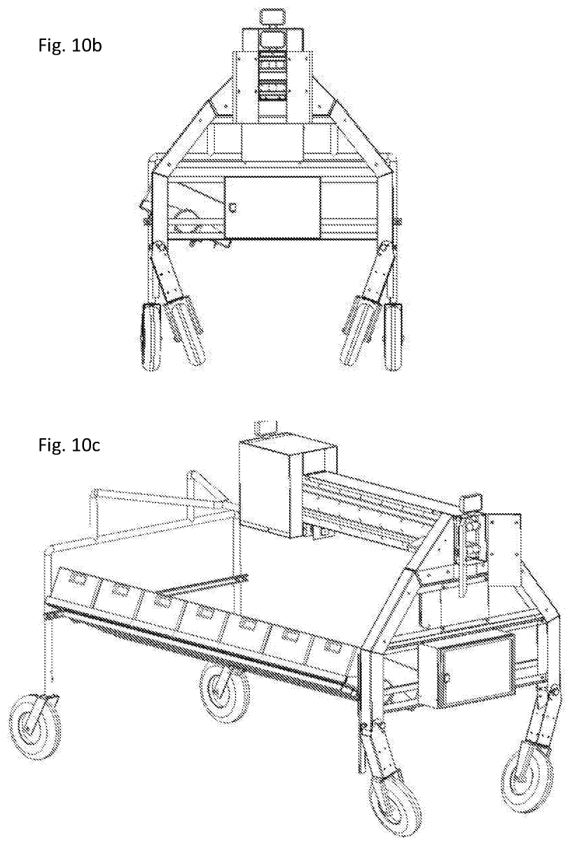

FIG. 10a shows a further version of the present machine, FIG. 10b a front view thereof, and FIG. 10 a perspective view. In these figures the carriers and gondolas are left out.

1. A module for transferring objects comprising
a frame with a longitudinal axis,
at least one first rotation system comprising at least one individually operable rotator, each rotator connected to the rotation system,
at least one carrier, each carrier connected to at least one rotator,
each carrier individually comprising a gondola, wherein said gondola is adapted to move within the carrier in a direction perpendicular to a movement of the carrier, per gondola an individually operable gondola driver for moving the gondola within the carrier,
each gondola comprising at least one object transferrer,
characterized in that
each rotator individually operable for rotating the carrier along a continuous track, wherein said track comprises two substantially linear track parts and two curved track parts in between said two linear parts, wherein said two substantially linear track parts are spaced apart and parallel to said longitudinal axis,
at least one controller for controlling the individually operable rotator and the gondola driver such that a gondola is at a given position at a given time, typically during a period of time, and
at least one driving system for driving the first rotation system and moving the gondola.

2. The module according to claim 1, characterized in that the module comprises at least two first rotation systems each comprising at least one individually operable rotator.

3. The module according to claim 1, characterized in that
per carrier two rotators are provided, wherein the two rotators are coupled to the carrier above and below one and another, respectively.

4. The module according to claim 1, characterized in that at least n carriers are coupled to the same rotator, wherein n is two or more.

5. The module according to claim 1, characterized in a feedback loop for spatially cycling each carrier from a back side to a front side of the frame and from a front side to a back side of the frame.

6. The module according to claim 1, characterized in that the object transferrer is a tongs.

7. The module according to claim 1, characterized in a carrier guidance, wherein the carrier guidance is adapted to move at a constant or zero speed.

8. The module according to claim 1, characterized in that the frame comprises at least one passage for allowing rotation of the at least one carrier in a cyclic manner.

9. The module according to claim 1, characterized in that the gondola comprises an object transferrer movable in a direction perpendicular to the longitudinal axis, in a vertical direction perpendicular to the longitudinal axis, and combinations thereof.

10. The module according to claim 1, characterized in that the rotator is selected from a belt, a chain, a toothed belt, and combinations thereof, and/or
wherein the gondola driver is selected from a belt, a chain, a toothed belt, and combinations thereof, and
wherein the gondola driver is provided eccentric in the frame, and
wherein the at least one controller comprises a closed loop, and
wherein the at least one controller is adapted to move the gondola in a position closer to the frame as the carrier is in at least one of the two curved track parts in between said two linear parts, and
wherein the gondola driver and rotator are provided with a gear, and
wherein the carrier and gondola are adapted to lock in with the gondola driver in one of the two curved track parts, and
comprising a calibration unit, and
wherein the gondola is adapted to move at a speed v₂ larger than a speed v₁ of the carrier when the carrier has left one of the two curved track parts and enters one of the two linear parts, wherein the gondola is adapted to move at a speed v₂ equal to a speed v₁ of the carrier when the carrier is in a mid-section of the one of the two linear parts, and wherein the gondola is adapted to move at a speed v₂ smaller than a speed v₁ of the carrier when the carrier leaves the one of the two linear parts and enters a second of the two curved track parts, and
wherein the gondola and carrier are adapted to transfer an object within 2 secs.

11. A machine for transferring objects comprising at least one module, the at least one module comprising:
a frame with a longitudinal axis,
at least one first rotation system comprising at least one individually operable rotator, each rotator connected to the rotation system,
at least one carrier, each carrier connected to at least one rotator,
each carrier individually comprising a gondola, wherein said gondola is adapted to move within the carrier in a direction perpendicular to a movement of the carrier, per gondola an individually operable gondola driver for moving the gondola within the carrier,
each gondola comprising at least one object transferrer,
characterized in that
each rotator individually operable for rotating the carrier along a continuous track, wherein said track comprises two substantially linear track parts and two curved track parts in between said two linear parts, wherein said two substantially linear track parts are spaced apart and parallel to said longitudinal axis,
at least one controller for controlling the individually operable rotator and the gondola driver such that a gondola is at a given position at a given time, typically during a period of time, and
at least one driving system for driving the first rotation system and moving the gondola.

12. The machine according to claim 11, wherein the machine is selected from harvesting machines, from packaging machines, from pick-and-place machines, from surface mount technology component placement systems, from pick-and-order machines, from non-static machines, and from postal selection machines.

13. The machine according to claim 11, wherein the gondola is a cutting module comprising an tongs for grasping an individual vegetable, a cutter, a vegetable locator, and wherein the cutting module is movably located in the carrier allowing movement in a horizontal direction perpendicular to the longitudinal axis.

14. The machine according to claim 11, wherein the machine comprises a movable frame, the movable frame comprising a motor and wheels, a speed controller.

15. The machine according to claim 11, wherein the machine comprises a central bottom passage for allowing free movement of the machine over a row of vegetables.

16. The machine according to claim 11, comprising a controller for controlling the at least one carrier and gondola, frame speed, and feedback loop speed.

17. The machine according to claim 11, comprising at least one location sensor, for detecting an individual vegetable.

18. The machine according to claim 11, wherein the gondola is a cutting module comprising a cutter, and the cutter comprises a vertical holder, a knife blade, and a knife blade protector, wherein the knife blade is adapted to rotate in a horizontal plane for cutting an individual vegetable.

19. The machine according to claim 11, wherein the gondola is a cutting module comprising a vegetable locator, and wherein the vegetable locator comprises at least two horizontally rotatable tactile sensors spaced apart at a distance of 1-10 cm, and oriented in a tapered geometry.
